(19) United States
(12) Patent Application Publication
(10) Pub. No.: US 2023/0336841 A1
(43) Pub. Date: Oct. 19, 2023

(54) SYSTEM AND METHOD FOR STREAMING IN METAVERSE SPACE

(71) Applicant: COLORVERSE INC., Seoul (KR)

(72) Inventor: Se Hyung JIN, Seoul (KR)

(21) Appl. No.: 18/336,693

(22) Filed: Jun. 16, 2023

Related U.S. Application Data
(63) Continuation of application No. PCT/KR2021/017374, filed on Nov. 24, 2021.

(30) Foreign Application Priority Data
Dec. 17, 2020 (KR) 10-2020-0177290

(51) Int. Cl. H04N 21/81; H04N 21/234; H04N 21/4782

(52) U.S. Cl. CPC H04N 21/816; H04N 21/234; H04N 21/4782

(57) ABSTRACT

The present invention is directed to a metaverse space streaming system and method. The present invention proposes a metaverse space streaming system, including: a metaverse space information storage unit configured to store information about metaverse spaces and information about a plurality of metaverse driving servers in association with each other; a metaverse driving server management unit configured to receive a metaverse access request from a user terminal and to select information about a metaverse space and a metaverse driving server corresponding to the metaverse access request from among the plurality of metaverse driving servers; and a metaverse driving server control unit configured to perform control so that the selected metaverse driving server streams a metaverse space image for the metaverse space corresponding to the metaverse access request to the user terminal, and a metaverse space streaming method.

### CROSS-REFERENCE TO RELATED APPLICATIONS

This application is a Continuation of International Application No. PCT/KR2021/017374 filed on Nov. 24, 2021, which claims priority to Korean Application No. 10-2020-0177290 filed on Dec. 17, 2020. The aforementioned applications are incorporated herein by reference in their entireties.

### TECHNICAL FIELD

The present invention relates to a metaverse streaming system and method, and more particularly, to a system and method that allow three-dimensional (3D) screens of virtual spaces constituting the metaverse to be provided through streaming, thereby minimizing terminal load and loading time.

### RELATED ART

Metaverse is a compound word of virtual/meta and world/universe, and means a 3D virtual world. More specifically, it is widely used in the sense of a life-type and game-type virtual world in which both reality and non-reality can coexist in overall aspects of politics, economy, society, and culture. With the development of 3D graphics technology, a technology is being developed to provide such a metaverse in a user terminal so that a user can feel as if he or she exists in a corresponding virtual space through the terminal.

Korean Patent No. 10-1923723 entitled “Metaverse Client Terminal and Method for Providing Metaverse Space where Users can Interact with Each Other,” which is a prior art, is directed to a technology that enables interaction between users in such a metaverse environment. A server integrates and manages information about the spaces of the metaverse and each terminal drives and displays 3D screens using this information so that multiple users can interact with each other in a metaverse environment.

However, it takes a lot of time and computing resources to load a 3D metaverse space and various characters or items arranged in the space using the metaverse space information of the server in each user's terminal as described above. In particular, in the recent environment where mobile services are mainstream, using a lot of computing resources of mobile devices and waiting for loading time for the purpose of making access to the metaverse cause significant inconvenience to users.

Therefore, there is a demand for technology that can minimize the load on the terminal and also minimize the loading time to rapidly access the metaverse even in a mobile environment.

### SUMMARY

An object of the present invention is to load a metaverse space in advance into a server and provide a service through streaming, thereby enabling a 3D metaverse to be provided without a separate loading time.

An object of the present invention is to allocate a metaverse driving server for each metaverse space and load resources from the server for each metaverse space, thereby enabling a 3D metaverse space to be used without terminal load.

An object of the present invention is to allocate a metaverse driving server for each metaverse space and allow the server to operate only while a user is accessing the metaverse space, thereby maximizing server efficiency.

An object of the present invention is to provide a metaverse service using image streaming, thereby enabling a metaverse service to be used without a separate terminal application.

An object of the present invention is to allow a metaverse space image to be streamed using HTML, thereby enabling a 3D metaverse service to be used without a separate loading time in any terminal with a web browser.

An object of the present invention is to deform a metaverse space in response to a user's button press, swipe, zoom-in, zoom-out, and/or the like in the metaverse space and transmit the results of the deformation to a user terminal through streaming, thereby enabling an interactive 3D metaverse service to be provided without a separate application.

In order to accomplish the above objects, an embodiment of the present invention provides a metaverse space streaming system including: a metaverse space information storage unit configured to store information about metaverse spaces and information about a plurality of metaverse driving servers in association with each other; a metaverse driving server management unit configured to receive a metaverse access request from a user terminal and to select information about a metaverse space and a metaverse driving server corresponding to the metaverse access request from among the plurality of metaverse driving servers; and a metaverse driving server control unit configured to perform control so that the selected metaverse driving server streams a metaverse space image for the metaverse space corresponding to the metaverse access request to the user terminal.

In this case, the metaverse space streaming system may further includes a server pool management unit configured to store information about a plurality of candidate servers that can operate as metaverse driving servers, and the metaverse driving server management unit may be further configured to, when there is no metaverse driving server corresponding to the metaverse connection request, receive information about a selected candidate server from the server pool management unit and drive the selected candidate server.

Furthermore, the metaverse driving server management unit may be further configured to transmit the information about the metaverse space corresponding to the metaverse access request to the selected candidate server; and the selected candidate server may be further configured to load the metaverse space and resources of the metaverse space based on the transferred information about the metaverse space.

Furthermore, the metaverse space information storage unit may be further configured to store information about the selected candidate server in association with the information about the metaverse space corresponding to the metaverse access request.

Furthermore, the server pool management unit may be further configured to select a metaverse driving server satisfying a predetermined condition from among the plurality of metaverse driving servers, to convert it into a candidate server, and to store information about the candidate server obtained through the conversion, and the metaverse space information storage unit may be further configured to delete information about the metaverse driving server converted into the candidate server.

Furthermore, the server pool management unit may be further configured to: check information about the number of user terminals that are streaming metaverse space images from the plurality of metaverse driving servers; and convert a server, for which a predetermined time has elapsed since the number of user terminals streaming metaverse space images becomes 0, into a candidate server.

Furthermore, the metaverse driving server may be further configured to: maintain the metaverse space and resources of the metaverse space in memory based on the corresponding information about the metaverse space; and, in response to a control command from the metaverse driving server control unit, render an image based on viewpoint and gaze information determined for each user terminal in the metaverse space, and stream the image to the user terminal.

Furthermore, the metaverse driving server may be further configured to: receive a control command from the user terminal; and, based on the received control command, control any one of the metaverse space, the resources of the metaverse space, and a viewpoint and gaze corresponding to the user terminal, and stream the metaverse space image, changed as a result of the control, to the user terminal.

The present invention may achieve the effect of loading a metaverse space in advance into a server and providing a service through streaming, thereby enabling a 3D metaverse to be provided without a separate loading time.

The present invention may achieve the effect of allocating a metaverse driving server for each metaverse space and loading resources from the server for each metaverse space, thereby enabling a 3D metaverse space to be used without terminal load.

The present invention may achieve the effect of allocating a metaverse driving server for each metaverse space and allowing the server to operate only while a user is accessing the metaverse space, thereby maximizing server efficiency.

The present invention may achieve the effect of providing a metaverse service using image streaming, thereby enabling a metaverse service to be used without a separate terminal application.

The present invention may achieve the effect of allowing a metaverse space image to be streamed using HTML, thereby enabling a 3D metaverse service to be used without a separate loading time in any terminal with a web browser.

The present invention may achieve the effect of deforming a metaverse space in response to a user's button press, swipe, zoom-in, zoom-out, and/or the like in the metaverse space and transmitting the results of the deformation to a user terminal through streaming, thereby enabling an interactive 3D metaverse service to be provided without a separate application.

### BRIEF DESCRIPTION OF THE DRAWINGS

FIG. 1 is a block diagram showing the configuration of a conventional 3D metaverse service;

FIG. 2 is a block diagram showing the overall configuration of a metaverse space streaming system according to an embodiment of the present invention;

FIG. 3 is a block diagram showing the internal configuration of a metaverse spatial streaming system according to an embodiment of the present invention;

FIG. 4 is a diagram illustrating an example of managing a metaverse driving server in a metaverse space streaming system according to an embodiment of the present invention;

FIG. 5 is a diagram illustrating an example of processing an unused metaverse driving server in a metaverse space streaming system according to an embodiment of the present invention; and

FIG. 6 is a flowchart showing the flow of a metaverse space streaming method according to an embodiment of the present invention.

### DETAILED DESCRIPTION

In order to accomplish the above objects, an embodiment of the present invention provides a metaverse space streaming system including: a metaverse space information storage unit configured to store information about metaverse spaces and information about a plurality of metaverse driving servers in association with each other; a metaverse driving server management unit configured to receive a metaverse access request from a user terminal and to select information about a metaverse space and a metaverse driving server corresponding to the metaverse access request from among the plurality of metaverse driving servers; and a metaverse driving server control unit configured to perform control so that the selected metaverse driving server streams a metaverse space image for the metaverse space corresponding to the metaverse access request to the user terminal.

In this case, the metaverse space streaming system may further includes a server pool management unit configured to store information about a plurality of candidate servers that can operate as metaverse driving servers, and the metaverse driving server management unit may be further configured to, when there is no metaverse driving server corresponding to the metaverse connection request, receive information about a selected candidate server from the server pool management unit and drive the selected candidate server.

Furthermore, the metaverse driving server management unit may be further configured to transmit the information about the metaverse space corresponding to the metaverse access request to the selected candidate server; and the selected candidate server may be further configured to load the metaverse space and resources of the metaverse space based on the transferred information about the metaverse space.

Furthermore, the metaverse space information storage unit may be further configured to store information about the selected candidate server in association with the information about the metaverse space corresponding to the metaverse access request.

Furthermore, the server pool management unit may be further configured to select a metaverse driving server satisfying a predetermined condition from among the plurality of metaverse driving servers, to convert it into a candidate server, and to store information about the candidate server obtained through the conversion, and the metaverse space information storage unit may be further configured to delete information about the metaverse driving server converted into the candidate server.

Furthermore, the server pool management unit may be further configured to: check information about the number of user terminals that are streaming metaverse space images from the plurality of metaverse driving servers; and convert a server, for which a predetermined time has elapsed since the number of user terminals streaming metaverse space images becomes 0, into a candidate server.

Furthermore, the metaverse driving server may be further configured to: maintain the metaverse space and resources of the metaverse space in memory based on the corresponding information about the metaverse space; and, in response to a control command from the metaverse driving server control unit, render an image based on viewpoint and gaze information determined for each user terminal in the metaverse space, and stream the image to the user terminal.

Furthermore, the metaverse driving server may be further configured to: receive a control command from the user terminal; and, based on the received control command, control any one of the metaverse space, the resources of the metaverse space, and a viewpoint and gaze corresponding to the user terminal, and stream the metaverse space image, changed as a result of the control, to the user terminal.

Hereinafter, preferred embodiments of the present invention will be described in detail with reference to the accompanying drawings. In the description of the present invention, when it is determined that a detailed description of a related known configuration or function may obscure the gist of the present invention, the detailed description will be omitted. In addition, in the description of embodiments of the present invention, specific numerical values are only examples, and the scope of the invention is not limited thereby.

A metaverse space streaming system according to the present invention may be configured in the form of a server that is equipped with a central processing unit (CPU) and memory and is connectable to another terminal over a communication network such as the Internet. However, the present invention is not limited by components such as the central processing unit, the memory, etc. Metaverse space streaming may be configured in a form in which a metaverse management server and a plurality of metaverse driving servers are connected to each other. Each of the servers may be a physically separate server, or may be a virtually separate server in a cloud environment. The present invention is not limited by the form of the configuration.

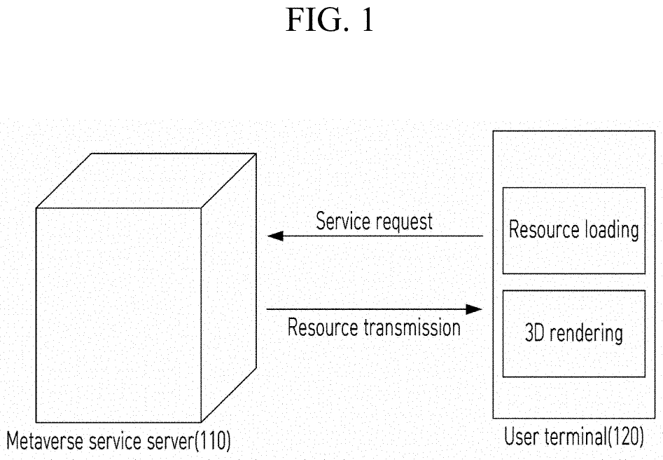

FIG. 1 is a block diagram showing the configuration of a conventional 3D metaverse service.

The conventional 3D metaverse service is configured such that a user terminal 120 accesses a metaverse service server 110 configured to store information about the metaverse, 3D characters, resources, etc. and utilizes the metaverse service.

To provide the 3D metaverse service, a system is operated in the form in which 3D model data (resources) is loaded into memory and 3D models within a viewing range are rendered and displayed on a 2D screen based on viewpoint and gaze information inside a 3D space.

The above-described resource loading and 3D rendering operations are performed in the user terminal 120. To this end, the user terminal 120 makes a service request to the metaverse service server 110 and receives metaverse service-related information and resources as a response to the service request. After resources have been loaded into the user terminal 120, a metaverse space may be displayed on the screen of the user terminal through a 3D rendering process.

However, this method has problems in that the process of loading resources and performing 3D rendering occurs in the user terminal, so that a lot of computing resources of the terminal are consumed and the metaverse service may not be used appropriately in the case where the terminal does not have a graphics processing unit (GPU) configured to process 3D graphics.

In particular, even when multiple users access the same metaverse space, the process of loading and rendering resources for the same space into each user terminal needs to be repeated, resulting in the unnecessary waste of computing resources.

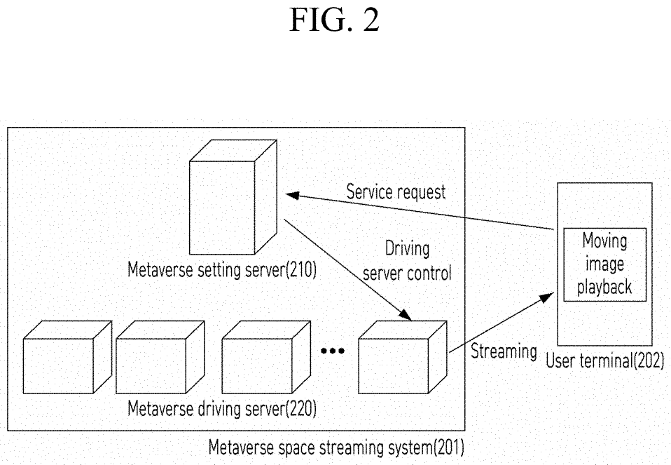

FIG. 2 is a block diagram showing the overall configuration of a metaverse space streaming system according to an embodiment of the present invention.

As shown in the drawing, the metaverse space streaming system 201 of the present invention may be configured to include a metaverse setting server 210 and a plurality of metaverse driving servers 220.

Unlike in the prior art in which the metaverse service server 110 transfers metaverse information and resources to the user terminal 120 and the user terminal performs a 3D graphics processing process on them, in the present invention, when a user terminal 202 transmits a service request to the metaverse setting server 210, the metaverse setting server 210 identifies a metaverse space, for which the service request is intended, by analyzing the service request and also identifies one of the metaverse driving servers 220 that corresponds to the corresponding metaverse space.

Once the metaverse setting server 210 has identified the metaverse driving server 220 that will provide the metaverse space, a control command is transmitted to the corresponding metaverse driving server 220, and an image of the corresponding metaverse space is streamed and transmitted to the user terminal 202 that has transmitted the service request.

The user terminal 202 may check the image of the 3D metaverse space in real time by playing back the image, transmitted using HTML 5, through the web browser of the terminal. Accordingly, since the user terminal 202 does not require the process of loading resources or processing 3D rendering and it is sufficient if a streaming moving image is played back, the 3D metaverse service may be provided regardless of the type or kind of terminal.

To this end, the metaverse driving server 220 loads space information about the allocated metaverse space and resources to be located in the space, and renders them using viewpoint and gaze information set for each user terminal 202, so that a streaming image for each user terminal 202 needs to be generated. Accordingly, the metaverse driving server 220 needs to have a sufficient number of graphics processing units (GPUs) capable of loading and rendering 3D resources and then generating image.

It is preferable that one metaverse driving server 220 is allocated for each metaverse space. However, since there is no need to maintain a server in the case where there is no user who is accessing each metaverse space, candidate servers are provided by taking into consideration this situation. When a user accessing a metaverse space for the first time appears, one of the candidate servers may be allocated to the metaverse space and drive the metaverse space. In the case of the user accessing the metaverse space for the first time, it may take some time to drive and load resources. Once the server has been allocated to the metaverse space and loading has been finished, users accessing the space may simultaneously check an image of the metaverse space in real time without additional loading time.

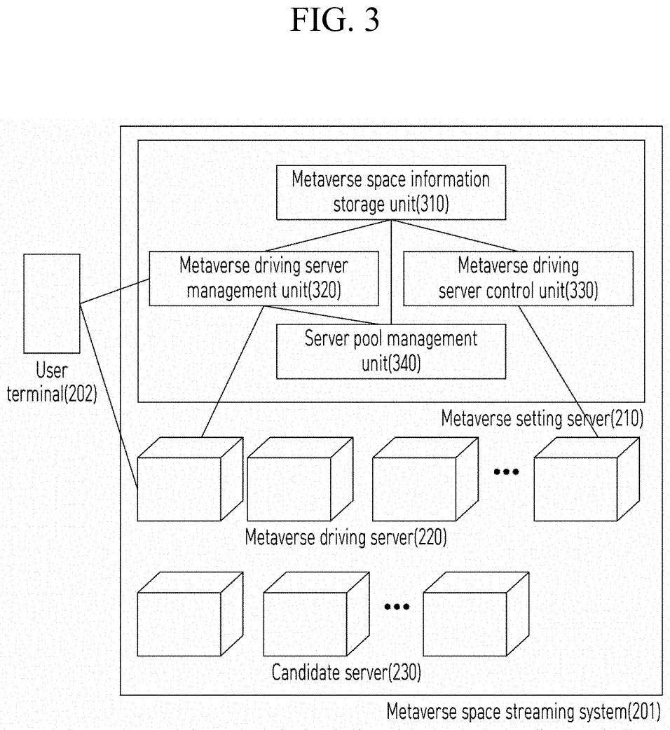

FIG. 3 is a block diagram showing the internal configuration of a metaverse spatial streaming system according to an embodiment of the present invention.

As shown in the drawing, the metaverse space streaming system 201 according to the embodiment of the present invention may be configured to include a metaverse setting server 210, metaverse driving servers 220, and candidate servers 230. The metaverse setting server 210 may be configured to include a metaverse space information storage unit 310, a metaverse driving server management unit 320, a metaverse driving server control unit 330, and a server pool management unit 340. The individual components may be software modules that operate in the physically same computer system, and may have forms that operate in such a manner that two or more physically separate computer systems are configured to operate in conjunction with each other. Various embodiments including the same functions fall within the scope of the present invention.

The metaverse space information storage unit 310 stores information about metaverse spaces and information about the plurality of metaverse driving servers 220 in association with each other. In the metaverse service, the metaverse refers to a virtual space, and the virtual space may be divided into and present as multiple spaces. For example, if there is a metaverse service in which a space such as his or her own house is allocated to each user, the user decorates the space, and users are allowed to visit other users' spaces, each virtual space generated by each user is a metaverse space.

The metaverse space may be constructed by setting the range and shape of space in a 3D virtual space, arranging 3D resources such as one or more items and decorations, acquired by a user within the range, and arranging the user's 3D character. When the virtual space is prepared as described above, a 2D image is generated by rendering the virtual 3D space, as in a case where a camera is located at the viewpoint of the user and photographing is performed in the gaze direction of the user by using information about the viewpoint and gaze of the user.

When the 2D image generated as described above is checked in the user terminal, an effect that looks like as if the actual user looked around the space in the corresponding metaverse space, i.e., the virtual 3D space, may be obtained.

Therefore, the metaverse space information storage unit 310 basically stores information about metaverse spaces. As described above, the information about metaverse spaces may include information about the shape and size of each of the metaverse spaces, various 3D resources to be present in the metaverse space, and information about 3D characters.

When the information about a metaverse space stored in the metaverse space information storage unit 310 as described above is used, the corresponding space may be reproduced on a two-dimensional display through a resource loading and rendering process.

The metaverse space information storage unit 310 also stores the information about metaverse spaces in association with the information about the metaverse driving servers 220. As described above in conjunction with FIG. 2, in the present invention, at least one metaverse driving server 220 is allocated for each of the metaverse spaces and the corresponding server performs a service for the metaverse space, so that the information about the metaverse driving servers 220 is stored in association with the information about metaverse spaces.

However, there may be a case where there is no corresponding metaverse driving server 220 in the information about metaverse spaces stored in the metaverse spatial information storage unit 310. This case corresponds to a case where there is no user who accesses a corresponding metaverse space and uses a service. Server resources may be efficiently used by dynamically allocating a server only when a user makes access so that it can be utilized as the metaverse driving server 220.

The metaverse driving server management unit 320 receives a metaverse assess request from the user terminal 202, and selects information about a metaverse space and the metaverse driving server 220 corresponding to the metaverse access request from among the plurality of metaverse driving servers 220.

The metaverse access request transmitted by the user terminal 202 may be an HTTP GET type request. In this case, access to the metaverse may be requested using a simple URL, thereby making it easy to request or induce access to the metaverse between users. By accessing the metaverse access URL sent by other users, a metaverse service may be used only by performing image streaming without installing an additional metaverse service program.

The metaverse access request transmitted by the user terminal 202 includes identifier information adapted to identify a metaverse space. Through this, the metaverse driving server management unit 320 may identify the metaverse space that is requested by the user, and may select information about a metaverse space corresponding to the identified metaverse space and the metaverse driving server 220 adapted to drive it by referring to the metaverse space information storage unit 310.

When there is no metaverse driving server 220 corresponding to the metaverse access request, the metaverse driving server management unit 320 may receive information about the candidate server 230 selected by the server pool management unit 340, and may drive the selected candidate server 230. As described above, when there is no user having accessed a corresponding metaverse space yet, there is also no metaverse driving server 220 for providing a service for the corresponding metaverse space yet. In this case, one of the candidate servers 230 may be selected, and may be driven as the metaverse driving server 220 for the corresponding metaverse space.

The metaverse driving server management unit 320 transfers information about a metaverse space corresponding to the metaverse access request to the selected candidate server 230, and the selected candidate server 230 loads the metaverse space and the resources of the metaverse space based on the transferred information about a metaverse space. In the process of initially setting the candidate server 230 as the metaverse driving server 220 as described above, it may take time to drive the server and load the resources. Thereafter, a user who accesses the metaverse space generates an image using resources already loaded into memory in the already driven metaverse driving server 220, so that real-time image streaming can be performed.

In this case, the metaverse space information storage unit 310 may store information about the selected candidate server 230 in association with the information about the metaverse space corresponding to the metaverse access request. Since the new candidate server 230 serves as a new metaverse driving server 220, it is now managed as the metaverse driving server 220, thereby making it possible to immediately respond to another user's access request in the future.

The metaverse driving server control unit 330 performs control so that the selected metaverse driving server 220 streams a metaverse space image for the metaverse space corresponding to the metaverse access request to the user terminal. When the metaverse driving server 220 has already been allocated to the metaverse space requested by the user, or when the process of driving and allocating one of the candidate servers 230 has been previously performed, the metaverse driving server 220 that will provide a service for the corresponding metaverse space is determined.

The metaverse driving server control unit 330 causes the metaverse driving server 220, allocated to the metaverse space and being driven as described above, to stream a metaverse space image to the user terminal 202. In order to stream the metaverse space image, the metaverse driving server control unit 330 needs to transfer information about the user terminal 202 to the metaverse driving server 220, and may also transfer information about the viewpoint and gaze of the user corresponding to the user terminal 202 within the metaverse space. Furthermore, control is performed such that a 3D character of the user corresponding to the user terminal 202 is placed in the metaverse space, so that interaction between characters of various users is enabled.

The server pool management unit 340 stores information about a plurality of candidate servers 230 that can operate as metaverse driving servers 220. As described above, when the metaverse driving servers 220 have been allocated for all the metaverse spaces, the metaverse driving server 220 allocated to a metaverse space that is not accessed by a user is present in an idle state. Therefore, in order to efficiently utilize server resources, unused servers are put into a server pool as candidate servers 230. When there is a service request for a new metaverse space, one of the candidate servers 230 is prepared as a metaverse driving server 220 and allowed to provide a service.

The server pool management unit 340 may select the metaverse driving server 220 satisfying a predetermined condition from among the plurality of metaverse driving servers 220, may convert the metaverse driving server 220 into a candidate server 230, and may store information about the candidate server obtained through the conversion. Server resources may be efficiently managed only when the server allocated as the metaverse driving server 220 and providing a service is also converted back into the candidate server 230 in a specific situation indicating that the corresponding server does not need to operate.

In this case, the metaverse space information storage unit 310 may delete information about the metaverse driving server 220 converted into the candidate server. Through this, when a service request for the metaverse space associated with the metaverse driving server 220 obtained through the conversion comes in again, the metaverse driving server management unit 320 newly selects one of the candidate servers 230 and loads information about the metaverse space into the selected candidate server 230, thereby generating a new metaverse driving server 220.

The server pool management unit 340 may check information about the number of user terminals streaming metaverse space images from the plurality of metaverse driving servers, and may convert a server, for which a predetermined time has elapsed since the number of user terminals performing streaming becomes 0, into a candidate server. The simplest way to identify a server that is not necessary is to identify a metaverse driving server 220 without a user terminal being accessing it. However, when the server is simply converted into the candidate server 230 only because there is no user who is currently accessing it, an operation such as resource loading is performed each time new access is made in the case of disconnecting for a while and then making access again, which reduces the effect of the invention.

Therefore, when it is determined that a predetermined time has elapsed after the number of user terminals becomes 0 and thus the service for the corresponding metaverse space is no longer used, the server pool management unit 340 converts the corresponding metaverse driving server 220 into a candidate server 230. In this case, the predetermined time may be equally applied to all the servers as a single time. Alternatively, a longer time may be allocated for the metaverse space that the user has accessed for a longer time, so that efficient management can be achieved.

The metaverse driving server 220 maintains the metaverse space and the resources of the metaverse space in memory based on information about the corresponding metaverse space, and may render an image based on the viewpoint and gaze information determined for each user terminal and stream the image to the user terminal in response to a control command of the metaverse driving server control unit.

In addition, the metaverse driving server 220 may receive a control command from the user terminal, may control any one of the metaverse space, the resources of the metaverse space, and a viewpoint and gaze corresponding to the user terminal based on the received control command, and may stream the metaverse space image, changed as a result of the control, to the user terminal. Through this, the user gives a control command through a touch on a screen, and this command is reflected in real-time in the corresponding metaverse space and is also reflected in real-time in one or more other user terminals accessing the same metaverse space, so that interaction between users is enabled.

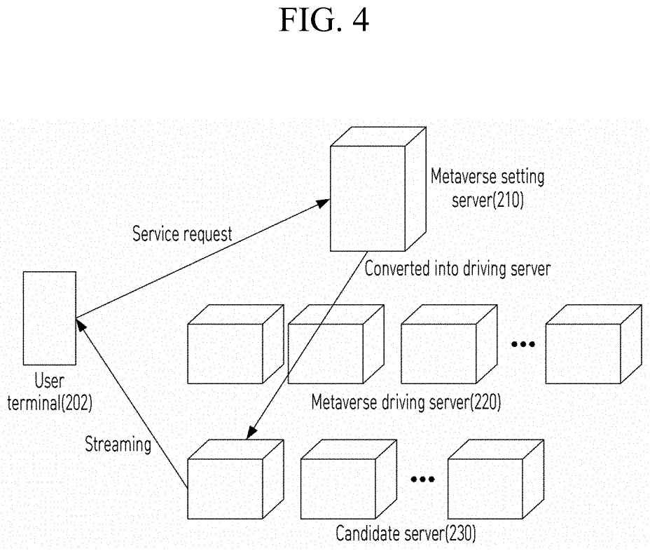

FIG. 4 is a diagram illustrating an example of managing a metaverse driving server in a metaverse space streaming system according to an embodiment of the present invention.

As shown in the drawing, in the case where a service request is transmitted from the user terminal 202 to the metaverse setting server 210, when, as a result of checking in the metaverse setting server 210, there is no metaverse driving server 220 for providing a metaverse space corresponding to the request among the operating metaverse driving servers 220, one of the candidate servers 230 may be prepared as a metaverse driving server 220.

In this case, the metaverse driving server 220 may be prepared by driving a physically separated server, or may be applied by separating the server into a plurality of virtual servers using technology such as cloud. However, the present invention is not limited by the configuration of the server.

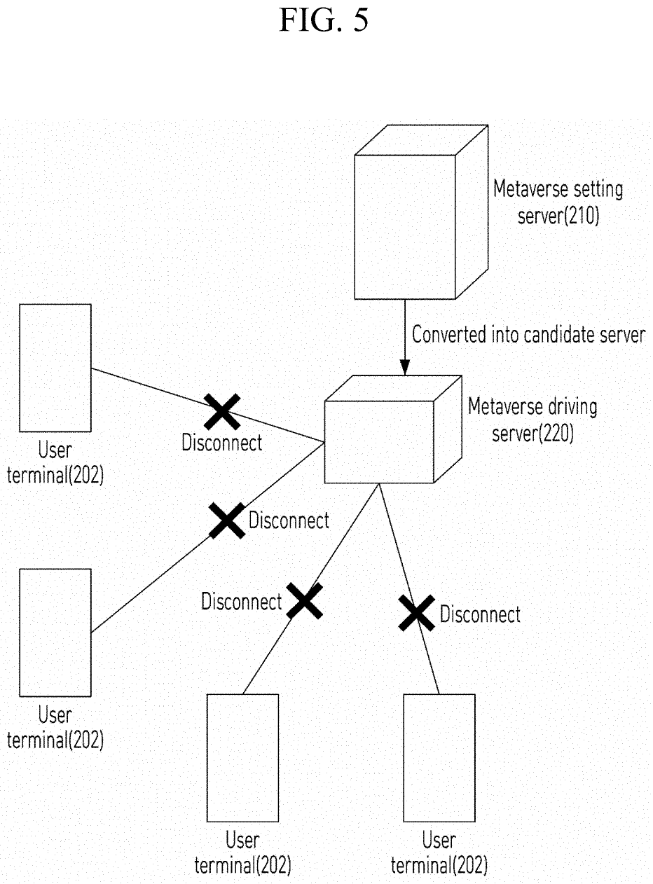

FIG. 5 is a diagram illustrating an example of processing an unused metaverse driving server in a metaverse space streaming system according to an embodiment of the present invention.

As shown in the drawing, when four user terminals 202 access one metaverse space and then the four terminals disconnect while the metaverse driving server 220 is providing services to the user terminals 202, the metaverse setting server 210 monitors the number of accesses. When a predetermined time has elapsed after the number of connected terminals becomes zero, a command is issued to convert the metaverse driving server 220 to the candidate server 230.

When the metaverse driving server 220 is converted into the candidate server 230 as described above, information about the metaverse driving server 220 corresponding to the metaverse space is deleted from the metaverse space information storage unit 310. Information about this server is included in the server pool management unit 340 and managed as a candidate server pool.

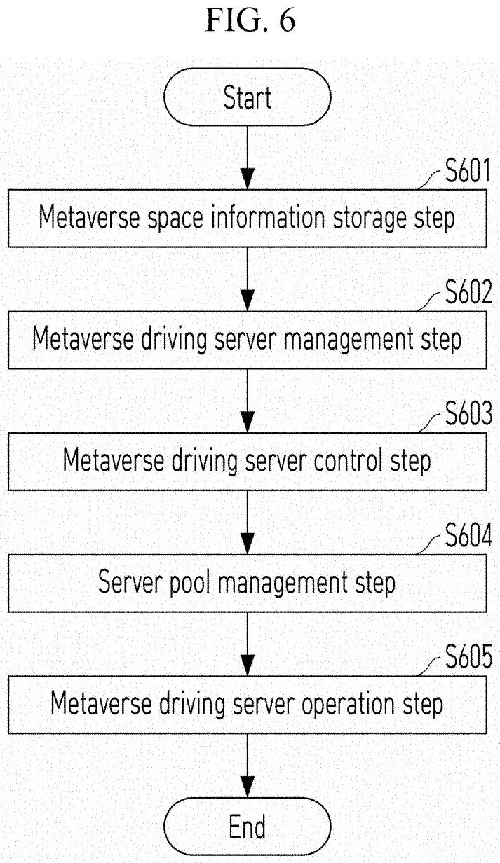

FIG. 6 is a flowchart showing the flow of a metaverse space streaming method according to an embodiment of the present invention.

The metaverse space streaming method according to the present invention is a method that is performed in the metaverse space streaming system 201 equipped with a central processing unit and memory, and may be driven, e.g., in a computing system.

Accordingly, the metaverse space streaming method includes all the characteristic configurations described in conjunction with the metaverse space streaming system 201 described above, and the items that will not be described in the following description can also be implemented with reference to the description of the metaverse space streaming system 202 described above.

In a metaverse space information storage step S601, information about metaverse spaces and information about the plurality of metaverse driving servers 220 are stored in association with each other. In the metaverse service, the metaverse refers to a virtual space, and the virtual space may be divided into and present as multiple spaces. For example, if there is a metaverse service in which a space such as his or her own house is allocated to each user, the user decorates the space, and users are allowed to visit other users' spaces, each virtual space generated by each user is a metaverse space.

In the metaverse space information storage step S601, information about metaverse spaces is basically stored. As described above, the information about metaverse spaces may include information about the shape and size of each of the metaverse spaces, various 3D resources to be present in the metaverse space, and information about 3D characters.

In the metaverse space information storage step S601, the information about metaverse spaces is also stored in association with the information about the metaverse driving servers 220. As described above in conjunction with FIG. 2, in the present invention, at least one metaverse driving server 220 is allocated for each of the metaverse spaces and the corresponding server performs a service for the metaverse space, so that the information about the metaverse driving servers 220 is stored in association with the information about metaverse spaces.

In a metaverse driving server management step S602, a metaverse assess request is received from the user terminal 202, and information about a metaverse space and the metaverse driving server 220 corresponding to the metaverse access request is selected from among the plurality of metaverse driving servers 220.

The metaverse access request transmitted by the user terminal 202 includes identifier information adapted to identify a metaverse space. Through this, in the metaverse driving server management step S602, the metaverse space that is requested by the user may be identified, and information about a metaverse space corresponding to the identified metaverse space and the metaverse driving server 220 adapted to drive it may be selected by referring to the information stored in the metaverse space information storage step S601.

In the metaverse driving server management step S602, when there is no metaverse driving server 220 corresponding to the metaverse access request, information about the candidate server 230 selected in the server pool management step S604 may be received, and the selected candidate server 230 may be driven. As described above, when there is no user having accessed a corresponding metaverse space yet, there is also no metaverse driving server 220 for providing a service for the corresponding metaverse space yet. In this case, one of the candidate servers 230 may be selected, and may be driven as the metaverse driving server 220 for the corresponding metaverse space.

In the metaverse driving server management step S602, information about a metaverse space corresponding to the metaverse access request is transferred to the selected candidate server 230, and the selected candidate server 230 loads the metaverse space and the resources of the metaverse space based on the transferred information about a metaverse space. In the process of initially setting the candidate server 230 as the metaverse driving server 220 as described above, it may take time to drive the server and load the resources. Thereafter, a user who accesses the metaverse space generates an image using resources already loaded into memory in the already driven metaverse driving server 220, so that real-time image streaming can be performed.

In this case, in the metaverse space information storage step S601, information about the selected candidate server 230 may be stored in association with the information about the metaverse space corresponding to the metaverse access request. Since the new candidate server 230 serves as a new metaverse driving server 220, it is now managed as the metaverse driving server 220, thereby making it possible to immediately respond to another user's access request in the future.

In the metaverse driving server control step S603, control is performed such that the selected metaverse driving server 220 streams a metaverse space image for the metaverse space corresponding to the metaverse access request to the user terminal. When the metaverse driving server 220 has already been allocated to the metaverse space requested by the user, or when the process of driving and allocating one of the candidate servers 230 has been previously performed, the metaverse driving server 220 that will provide a service for the corresponding metaverse space is determined.

In the metaverse driving server control step S603, the metaverse driving server 220, allocated to the metaverse space and being driven as described above, is caused to stream a metaverse space image to the user terminal 202. In the metaverse driving server control step S603, in order to stream the metaverse space image, information about the user terminal 202 needs to be transferred to the metaverse driving server 220, and information about the viewpoint and gaze of the user corresponding to the user terminal 202 within the metaverse space may also be transferred. Furthermore, control is performed such that a 3D character of the user corresponding to the user terminal 202 is placed in the metaverse space, so that interaction between characters of various users is enabled.

In a server pool management step S604, information about a plurality of candidate servers 230 that can operate as metaverse driving servers 220 is stored. As described above, when the metaverse driving servers 220 have been allocated for all the metaverse spaces, the metaverse driving server 220 allocated to a metaverse space that is not accessed by a user is present in an idle state. Therefore, in order to efficiently utilize server resources, unused servers are put into a server pool as candidate servers 230. When there is a service request for a new metaverse space, one of the candidate servers 230 is prepared as a metaverse driving server 220 and allowed to provide a service.

In the server pool management step S604, the metaverse driving server 220 satisfying a predetermined condition may be selected from among the plurality of metaverse driving servers 220, the metaverse driving server 220 may be converted into a candidate server 230, and information about the candidate server obtained through the conversion may be stored. Server resources may be efficiently managed only when the server allocated as the metaverse driving server 220 and providing a service is also converted back into the candidate server 230 in a specific situation indicating that the corresponding server does not need to operate.

In this case, in a metaverse space information storage step S601, information about the metaverse driving server 220 converted into the candidate server may be deleted. Through this, when a service request for the metaverse space associated with the metaverse driving server 220 obtained through the conversion comes in again, one of the candidate servers 230 is newly selected and information about the metaverse space is loaded into the selected candidate server 230, thereby generating a new metaverse driving server 220 in a metaverse driving server management step S602.

In this case, in the metaverse space information storage step S601, information about the number of user terminals streaming metaverse space images from the plurality of metaverse driving servers may be checked, and a server, for which a predetermined time has elapsed since the number of user terminals performing streaming becomes 0, may be converted into a candidate server. The simplest way to identify a server that is not necessary is to identify a metaverse driving server 220 without a user terminal being accessing it. However, when the server is simply converted into the candidate server 230 only because there is no user who is currently accessing it, an operation such as resource loading is performed each time new access is made in the case of disconnecting for a while and then making access again, which reduces the effect of the invention.

Therefore, in the server pool management step S604, when it is determined that a predetermined time has elapsed after the number of user terminals becomes 0 and thus the service for the corresponding metaverse space is no longer used, the corresponding metaverse driving server 220 is converted into a candidate server 230. In this case, the predetermined time may be equally applied to all the servers as a single time. Alternatively, a longer time may be allocated for the metaverse space that the user has accessed for a longer time, so that efficient management can be achieved.

In a metaverse driving server operation step S605, the metaverse space and the resources of the metaverse space may be maintained in memory based on information about the corresponding metaverse space, and an image may be rendered based on the viewpoint and gaze information determined for each user terminal and streamed to the user terminal in response to a control command of the metaverse driving server control unit.

In addition, in the metaverse driving server operation step S605, a control command may be received from the user terminal, any one of the metaverse space, the resources of the metaverse space, and a viewpoint and gaze corresponding to the user terminal may be controlled based on the received control command, and the metaverse space image changed as a result of the control may be streamed to the user terminal. Through this, the user gives a control command through a touch on a screen, and this command is reflected in real-time in the corresponding metaverse space and is also reflected in real-time in one or more other user terminals accessing the same metaverse space, so that interaction between users is enabled.

The metaverse space streaming method according to the present invention may be produced as a program that causes a computer to perform the metaverse space streaming method, and may be recorded on a non-transitory computer-readable storage medium.

Examples of the non-transitory computer-readable storage medium include magnetic media such as hard disks, floppy disks and magnetic tapes, optical storage media such as CDROMs and DVDs, magneto-optical media such as floptical disks, and hardware devices specially configured to store and execute program instructions, such as ROM, RAM, flash memory, and the like.

Examples of the program instructions include high-level language codes executable by a computer using an interpreter or the like as well as machine language codes such as those produced by a compiler. The hardware devices may each be configured to act as one or more software modules in order to perform processing according to the present invention, and vice versa.

Although the foregoing description has been given with reference to the embodiments, those skilled in the art may modify and alter the present invention in various manners without departing from the spirit and scope of the present invention described in the claims below.

The present invention is directed to a metaverse space streaming system and method. The present invention proposes a metaverse space streaming system, including: a metaverse space information storage unit configured to store information about metaverse spaces and information about a plurality of metaverse driving servers in association with each other; a metaverse driving server management unit configured to receive a metaverse access request from a user terminal and to select information about a metaverse space and a metaverse driving server corresponding to the metaverse access request from among the plurality of metaverse driving servers; and a metaverse driving server control unit configured to perform control so that the selected metaverse driving server streams a metaverse space image for the metaverse space corresponding to the metaverse access request to the user terminal, and a metaverse space streaming method.

What is claimed is:

1. A metaverse space streaming system comprising:
a metaverse space information storage unit configured to store information about metaverse spaces and information about a plurality of metaverse driving servers in association with each other;
a metaverse driving server management unit configured to receive a metaverse access request from a user terminal and to select information about a metaverse space and a metaverse driving server corresponding to the metaverse access request from among the plurality of metaverse driving servers; and
a metaverse driving server control unit configured to perform control so that the selected metaverse driving server streams a metaverse space image for the metaverse space corresponding to the metaverse access request to the user terminal.

2. The metaverse space streaming system of claim 1, further comprising a server pool management unit configured to store information about a plurality of candidate servers that can operate as metaverse driving servers,
wherein the metaverse driving server management unit is further configured to, when there is no metaverse driving server corresponding to the metaverse connection request, receive information about a selected candidate server from the server pool management unit and drive the selected candidate server.

3. The metaverse space streaming system of claim 2, wherein the metaverse driving server management unit is further configured to transmit the information about the metaverse space corresponding to the metaverse access request to the selected candidate server, and
wherein the selected candidate server is further configured to load the metaverse space and resources of the metaverse space based on the transferred information about the metaverse space.

4. The metaverse space streaming system of claim 3, wherein the metaverse space information storage unit is further configured to store information about the selected candidate server in association with the information about the metaverse space corresponding to the metaverse access request.

5. The metaverse space streaming system of claim 4, wherein the server pool management unit is further configured to select a metaverse driving server satisfying a predetermined condition from among the plurality of metaverse driving servers, to convert it into a candidate server, and to store information about the candidate server obtained through the conversion, and
wherein the metaverse space information storage unit is further configured to delete information about the metaverse driving server converted into the candidate server.

6. The metaverse space streaming system of claim 5, wherein the server pool management unit is further configured to:
check information about a number of user terminals that are streaming metaverse space images from the plurality of metaverse driving servers; and
convert a server, for which a predetermined time has elapsed since the number of user terminals streaming metaverse space images becomes 0, into a candidate server.

7. The metaverse space streaming system of claim 1, wherein the metaverse driving server is further configured to:
maintain the metaverse space and resources of the metaverse space in memory based on the corresponding information about the metaverse space; and
in response to a control command from the metaverse driving server control unit, render an image based on viewpoint and gaze information determined for each user terminal in the metaverse space, and stream the image to the user terminal.

8. The metaverse space streaming system of claim 7, wherein the metaverse driving server is further configured to:
receive a control command from the user terminal; and
based on the received control command, control any one of the metaverse space, the resources of the metaverse space, and a viewpoint and gaze corresponding to the user terminal, and stream the metaverse space image, changed as a result of the control, to the user terminal.

9. A metaverse space streaming method for a metaverse space streaming system having a central processing unit and memory, the metaverse space streaming method comprising:
a metaverse space information storage step of storing information about metaverse spaces and information about a plurality of metaverse driving servers in association with each other;
a metaverse driving server management step of receiving a metaverse access request from a user terminal and selecting information about a metaverse space and a metaverse driving server corresponding to the metaverse access request from among the plurality of metaverse driving servers; and
a metaverse driving server control step of performing control so that the selected metaverse driving server streams a metaverse space image for the metaverse space corresponding to the metaverse access request to the user terminal.

10. The metaverse space streaming method of claim 9, further comprising a server pool management step of storing information about a plurality of candidate servers that can operate as metaverse driving servers,
wherein the metaverse driving server management step comprises, when there is no metaverse driving server corresponding to the metaverse connection request, receiving information about a selected candidate server from the server pool management unit and driving the selected candidate server.

11. The metaverse space streaming method of claim 10, wherein the metaverse driving server management step further comprises transmitting the information about the metaverse space corresponding to the metaverse access request to the selected candidate server, and
wherein the selected candidate server loads the metaverse space and resources of the metaverse space based on the transferred information about the metaverse space.

12. The metaverse space streaming method of claim 11, wherein the metaverse space information storage step comprises storing information about the selected candidate server in association with the information about the metaverse space corresponding to the metaverse access request.

13. The metaverse space streaming method of claim 12, wherein the server pool management step comprises selecting a metaverse driving server satisfying a predetermined condition from among the plurality of metaverse driving servers, converting it into a candidate server, and storing information about the candidate server obtained through the conversion, and
wherein the metaverse space information storage unit is further configured to delete information about the metaverse driving server converted into the candidate server.

14. The metaverse space streaming method of claim 13, wherein the server pool management step further comprises:
checking information about a number of user terminals that are streaming metaverse space images from the plurality of metaverse driving servers; and
converting a server, for which a predetermined time has elapsed since the number of user terminals streaming metaverse space images becomes 0, into a candidate server.

15. The metaverse space streaming method of claim 9, further comprising a metaverse driving server operation step, which comprises:
in the metaverse driving server, maintaining the metaverse space and resources of the metaverse space in the memory based on the corresponding information about the metaverse space; and
in response to a control command from the metaverse driving server control unit, rendering an image based on viewpoint and gaze information determined for each user terminal in the metaverse space, and streaming the image to the user terminal.

16. The metaverse space streaming method of claim 15, wherein the metaverse driving server operation step comprises:
receiving a control command from the user terminal; and
based on the received control command, controlling any one of the metaverse space, the resources of the metaverse space, and a viewpoint and gaze corresponding to the user terminal, and streaming the metaverse space image, changed as a result of the control, to the user terminal.

17. A non-transitory computer-readable storage medium having stored thereon a program that causes a computer to perform the metaverse space streaming method of claim 9.
